(19) United States
(12) Patent Application Publication
(10) Pub. No.: US 2025/0045036 A1
(43) Pub. Date: Feb. 6, 2025

(54) REMOTELY GUIDING SEQUENCES OF OPERATIONAL INSTRUCTIONS

(71) Applicant: International Business Machines Corporation, Armonk, NY (US)

(72) Inventors: Dong Chen, Beijing (CN); Ming Lei Zhang, Beijing (CN); Ting Ting Zhan, Beijing (CN); Yuan Jie Zhang, Ningbo (CN); Yin Xi Guo, Beijing (CN)

(21) Appl. No.: 18/230,023

(22) Filed: Aug. 3, 2023

(51) Int. Cl. G06F 8/65

(52) U.S. Cl. CPC G06F 8/65

(57) ABSTRACT

A computer-implemented method, according to one embodiment, includes: receiving an initial sequence of operational instructions configured to update software programming in an electronic device. Contradicting ones of the operational instructions in the initial sequence are identified, and differences between the contradicting operational instructions are compared. As a result, the contradicting operational instructions are rectified by modifying the initial sequence of operational instructions. The software programming in the electronic device is also updated by implementing the modified sequence of operational instructions.

### BACKGROUND

The present invention relates to electronic devices, and more specifically, this invention relates to integrating with electronic devices to update software settings therein.

Electronic devices like mobile phones have continued to be adopted for a variety of situations in daily life. As electronic devices have become more advanced over time and gained functionality, they have been able to perform a wider array of actions. For instance, individuals can download software applications on their mobile phones. These software applications are each configured to utilize different characteristics of the mobile phones to perform specific actions.

While this added functionality has increased the convenience that electronic devices provide, it has also increased the complexity of operating electronic devices. For instance, different software applications often incorporate different procedures and may involve different system settings. It follows that causing an electronic device (e.g., mobile phone) to perform as desired may first involve performing a number of detailed setup procedures.

### SUMMARY

A computer-implemented method, according to one embodiment, includes: receiving an initial sequence of operational instructions configured to update software programming in an electronic device. Contradicting ones of the operational instructions in the initial sequence are identified, and differences between the contradicting operational instructions are compared. As a result, the contradicting operational instructions are rectified by modifying the initial sequence of operational instructions. The software programming in the electronic device is also updated by implementing the modified sequence of operational instructions.

A computer program product, according to another embodiment, includes a computer readable storage medium having program instructions embodied therewith. The program instructions are readable by a processor, executable by the processor, or readable and executable by the processor, to cause the processor to: perform the foregoing method.

A system, according to yet another embodiment, includes: a processor, and logic that is integrated with the processor, executable by the processor, or integrated with and executable by the processor. Moreover, the logic is configured to: perform the foregoing method.

Other aspects and implementations of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one approach.

FIG. 2 is a representational view of a distributed system, in accordance with one approach.

FIG. 3A is a flowchart of a method, in accordance with one approach.

FIG. 3B is a flowchart of sub-processes for one of the operations in the method of FIG. 3A, in accordance with one approach.

FIG. 3C is a flowchart of sub-processes for one of the operations in the method of FIG. 3A, in accordance with one approach.

FIG. 4 is a representational view of a distributed system, in accordance with one in-use example.

FIG. 5 is a flowchart of a method, in accordance with one embodiment of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches of systems, methods and computer program products for automatically generating sequences of instructional procedures configured to integrate with the operating system of an electronic device to update software therein. Moreover, these instructional procedures may be modified in real-time in response to inputs received from a user, known information (e.g., manufacturer provided instructional literature, information posted on a trusted website, etc.), and other factors, to improve the effectiveness and accuracy of the resulting software settings, e.g., as will be described in further detail below, e.g., as will be described in further detail below.

In one general embodiment, a computer-implemented method includes: receiving an initial sequence of operational instructions configured to update software programming in an electronic device. Contradicting ones of the operational instructions in the initial sequence are identified, and differences between the contradicting operational instructions are compared. As a result, the contradicting operational instructions are rectified by modifying the initial sequence of operational instructions. The software programming in the electronic device is also updated by implementing the modified sequence of operational instructions.

In another general embodiment, a computer program product includes a computer readable storage medium having program instructions embodied therewith. The program instructions are readable by a processor, executable by the processor, or readable and executable by the processor, to cause the processor to: perform the foregoing method.

In yet another general embodiment, a system includes: a processor, and logic that is integrated with the processor, executable by the processor, or integrated with and executable by the processor. Moreover, the logic is configured to: perform the foregoing method.

Various aspects of the present disclosure are described by narrative text, flowcharts, block diagrams of computer systems and/or block diagrams of the machine logic included in computer program product (CPP) approaches. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product implementation (“CPP implementation” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as improved software guidance code at block 150 for automatically generating sequences of procedures configured to integrate with the operating system of an electronic device to update software therein. In addition to block 150, computing environment 100 includes, for example, computer 101, wide area network (WAN) 102, end user device (EUD) 103, remote server 104, public cloud 105, and private cloud 106. In this approach, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

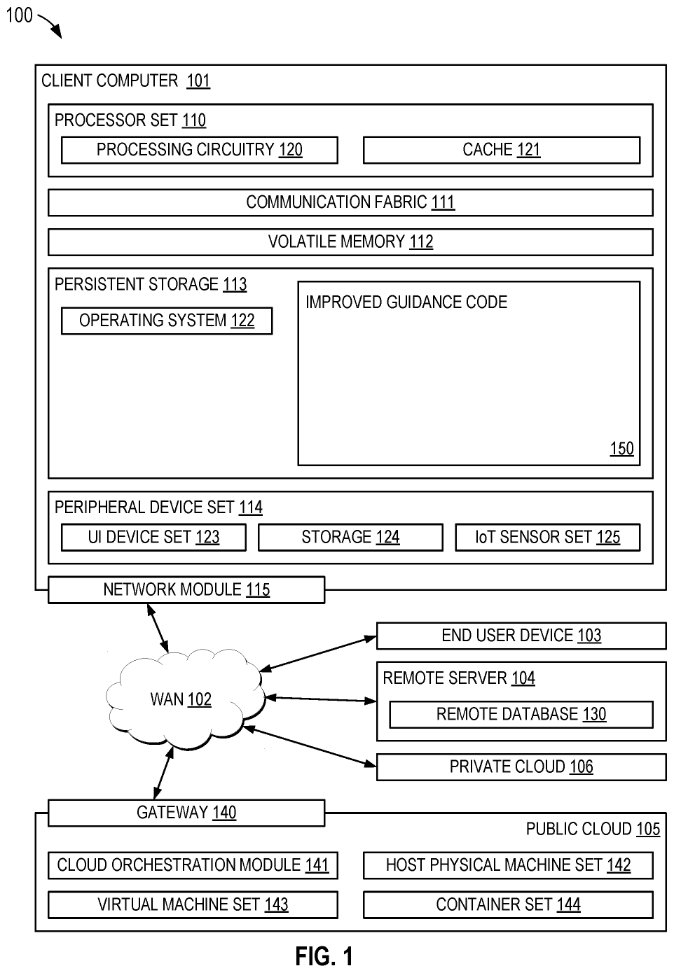

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various approaches, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some implementations, storage 124 may take the form of a quantum computing storage device for storing data in the form of qubits. In implementations where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some implementations, network control functions and network forwarding functions of network module 115 are performed on the same physical hardware device. In other implementations (for example, implementations that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some implementations, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some implementations, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other implementations a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this approach, public cloud 105 and private cloud 106 are both part of a larger hybrid cloud.

In some respects, a system according to various implementations may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various implementations.

As noted above, individuals have grown to use electronic devices for a variety of situations in daily life. Electronic devices like mobile phones have become more advanced over time and thereby have gained functionality, allowing them to perform a wider array of actions. For instance, individuals can download software applications on their mobile phones which are configured to utilize different characteristics of the mobile phones to perform specific actions.

While this added functionality has increased the convenience that electronic devices provide, it has also increased the complexity of operating electronic devices. For instance, different software applications often incorporate different procedures and may involve different system settings. It follows that causing an electronic device (e.g., mobile phone) to perform as desired may first involve performing a number of detailed setup procedures. These setup procedures and other details associated with using an electronic device in different situations to achieve different results are complicated and prone to errors during implementation.

Options are limited in situations where an electronic device is experiencing errors. For instance, operating settings for an electronic device are significantly complicated. Additionally, different software applications often incorporate different procedures and may involve different system settings, e.g., as noted above. Errors experienced by an electronic device are thereby often unique to the given situation, and difficult to explain to remote locations offering assistance.

These remote locations are also unable to deliver effective instructions on how to remedy the errors experienced. For instance, conventional systems require individuals to discuss steps for correcting experienced errors over a telephone (e.g., audio) connection. This disconnect between the instructions on how to remedy errors and the device experiencing the errors often leads to additional errors. As a result, conventional products have been unable to efficiently overcome technical errors that occur for electronic devices, leading to ineffective use of the devices themselves.

In sharp contrast, implementations herein are able to automatically generate instructional procedures that integrate with the operating system of an electronic device to provide directed input on how to achieve a desired software result (e.g., overcome an error). Moreover, these instructional procedures may be modified in real-time in response to input received from a user, known information (e.g., manufacturer provided instructional literature, information posted on a trusted website, etc.), and other factors, to improve the effectiveness and accuracy of the resulting software settings, e.g., as will be described in further detail below.

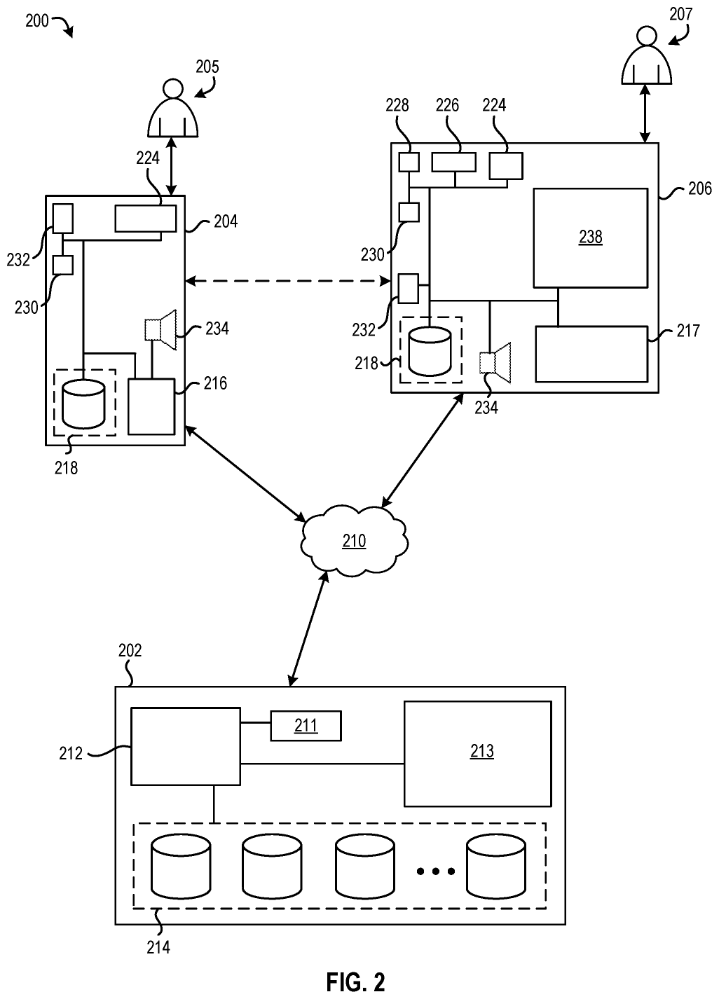

Looking now to FIG. 2, a system 200 having a distributed architecture is illustrated in accordance with one approach. As an option, the present system 200 may be implemented in conjunction with features from any other approach listed herein, such as those described with reference to the other FIGS., such as FIG. 1. However, such system 200 and others presented herein may be used in various applications and/or in permutations which may or may not be specifically described in the illustrative approaches or implementations listed herein. Further, the system 200 presented herein may be used in any desired environment. Thus FIG. 2 (and the other FIGS.) may be deemed to include any possible permutation.

As shown, the system 200 includes a central server 202 that is connected to electronic devices 204, 206 accessible to the respective user 205 and administrator 207. The electronic devices 204, 206 and central server 202 may thereby be separated from each other such that they are positioned in different geographical locations. For instance, the central server 202 and electronic devices 204, 206 are connected to a network 210.

The network 210 may be of any type, e.g., depending on the desired approach. For instance, in some approaches the network 210 is a WAN, e.g., such as the Internet. However, an illustrative list of other network types which network 210 may implement includes, but is not limited to, a LAN, a PSTN, a SAN, an internal telephone network, etc. As a result, any desired information, data, commands, instructions, responses, requests, etc. may be sent between user 205 and administrator 207, using the electronic devices 204, 206 and/or central server 202, regardless of the amount of separation which exists therebetween, e.g., despite being positioned at different geographical locations.

However, it should be noted that two or more of the electronic devices 204, 206 and/or central server 202 may be connected differently depending on the approach. According to an example, which is in no way intended to limit the invention, two edge compute nodes may be located relatively close to each other and connected by a wired connection, e.g., a cable, a fiber-optic link, a wire, etc.; etc., or any other type of connection which would be apparent to one skilled in the art after reading the present description. The term “user” is in no way intended to be limiting either. For instance, while users are described as being individuals in various implementations herein, a user may be an application, an organization, a preset process, etc. The use of “data” and “information” herein is in no way intended to be limiting either, and may include any desired type of details, e.g., depending on the type of prompt (e.g., request) submitted by a user.

With continued reference to FIG. 2, the electronic devices 204, 206 and central server 202 are shown as having different configurations. For example, the central server 202 includes a large (e.g., robust) processor 212 coupled to a cache 211, a machine learning module 213, as well as a data storage array 214 having a relatively high storage capacity. The machine learning module 213 may include any desired number and/or type of machine learning models. In preferred approaches, the machine learning module 213 includes machine learning models that have been trained to generate sequences of operational instructions (e.g., sequence of steps) configured to overcome issues experienced. Accordingly, in some approaches the machine learning module 213 may be used to evaluate requests received from user 205 and/or administrator 207, analyze those requests, and generate unique responses to the received requests, e.g., as would be appreciated by one skilled in the art after reading the present description. It follows that the machine learning module 213 at a central server 202 may be used in some implementations to generate at least a portion of a sequence of operational instructions, e.g., as described below with respect to method 300.

With continued reference to FIG. 2, electronic device 204 includes a processor 216 coupled to memory 218. The processor 216 is also connected to a display screen 224, a microphone 230, a camera 232, and an audio speaker 234. Accordingly, the processor 216 may receive inputs from user 205 using one or more of: the display screen 224 (e.g., using keys of a virtual computer keyboard, a touch screen, etc.), the microphone 230, and the camera 232. The processor 216 may thereby be configured to receive inputs (e.g., text, sounds, images, motion data, etc.) from any of these components as entered by the user 205.

These inputs typically correspond to information presented on the display screen 224 while the entries were received. Moreover, the inputs received may impact the information shown on display screen 224, data stored in memory 218, information collected from the microphone 230 and/or camera 232, status of an operating system being implemented by processor 216, etc.

In some situations, user 205 may input requests for assistance with the electronic device 204 itself and/or software being run on the electronic device 204. For example, user 205 may be having trouble using an application installed on the electronic device 204 (e.g., mobile phone), updating the operating software of the electronic device 204, accessing data stored on the electronic device 204 and/or elsewhere (e.g., remotely at data storage array 214 of central server 202), etc.

The user 205 may thereby send a request for assistance to administrator 207. The administrator 207 may be a designated contact (e.g., a designated information technology (IT) professional), chosen by the user 205 submitting the request for assistance, identified in response to accepting the request sent from user 205, etc. The processor 216 may thereby direct a request received from user 205 over network 210, to electronic device 206 and administrator 207.

There, the request is preferably reviewed in real-time by electronic device 206 and/or administrator 207 to determine a desired solution. As noted above, the request may be sent by user 205 in response to experiencing an issue at electronic device 204. The request is thereby preferably evaluated to determine potential solutions to the issue. For instance, electronic device 206 includes a machine learning module 238 which may be used to evaluate the request, consider available solutions to the request, and generate a suggested solution. It follows that the machine learning module 238 may include any desired number and/or type of machine learning models that have been trained to overcome a variety of different issues that can be experienced by electronic devices.

Similarly, the administrator 207 may provide a suggested solution to an issue raised by user 205. In some situations, the administrator 207 may verbally explain the steps in a suggested solution, thereby generating audio signals captured by microphone 230 and sent to controller 217 for processing. In other situations, the administrator 207 may submit a suggested solution using a display screen 224, keys of a computer keyboard 226, a computer mouse 228, and/or camera 232 of the electronic device 206.

It follows that controller 217 may be configured to process the different types of information received from the administrator 207 and/or machine learning module 238 in response to receiving a request for software assistance from user 205. In some approaches, the controller 217 includes voice recognition software and is configured to interpret vocal signals received from the administrator 207. The controller 217 may also be configured to perform keyword extraction, natural language processing, etc., to analyze inputs received from administrator 207 and/or machine learning module 238. In other approaches, the controller 217 may include image recognition software for evaluating images, text recognition software for interpreting typed and/or handwritten characters, etc. It follows that controller 217 may be used to address requests for assistance received from user 205, by performing one or more of the operations in method 300 below, e.g., as will soon become apparent.

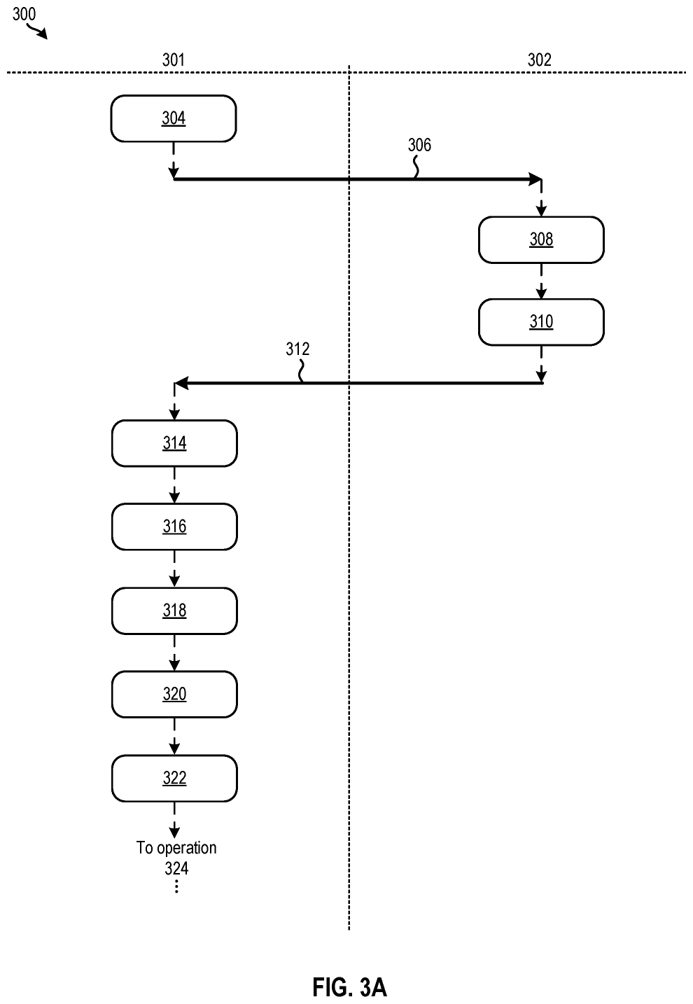

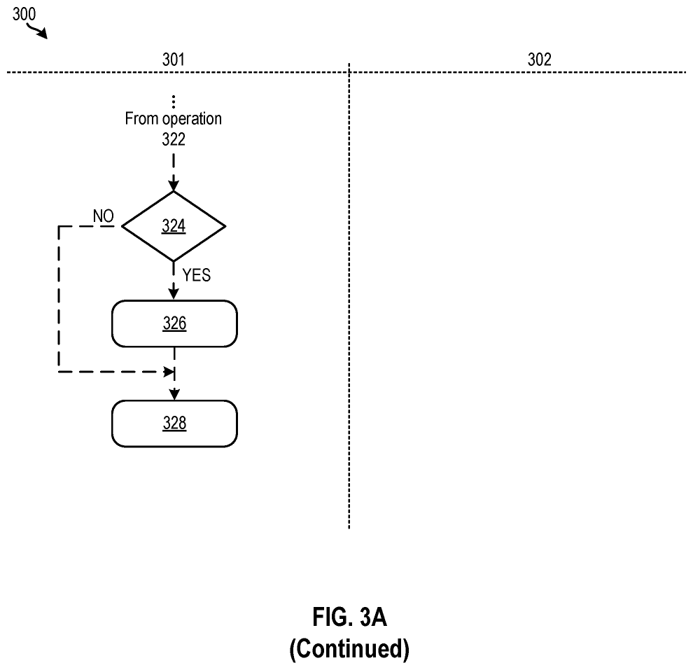

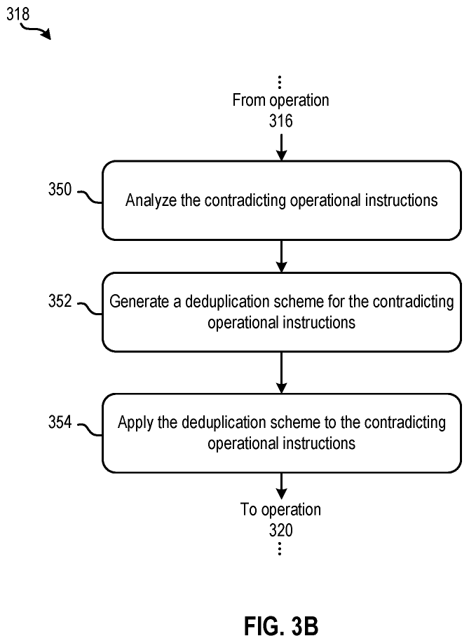

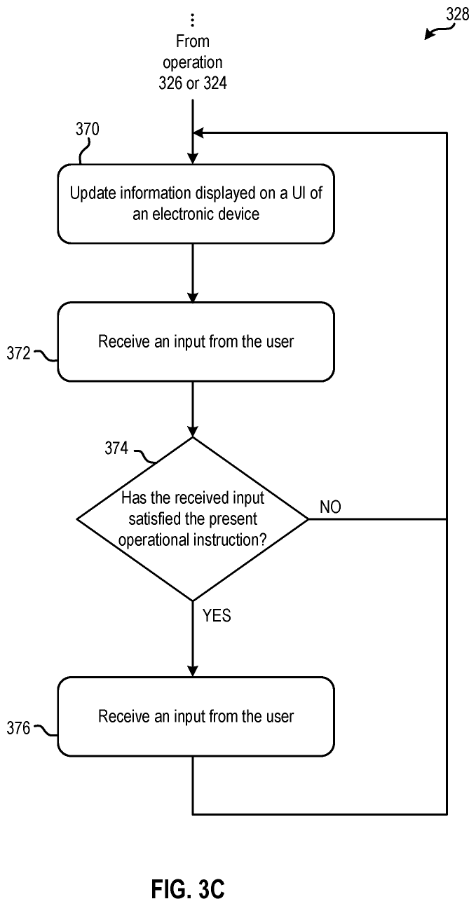

Now referring to FIG. 3A, a flowchart of a computer-implemented method 300 is shown according to one embodiment. The method 300 may be performed in accordance with the present invention in any of the environments depicted in FIGS. 1-2, among others, in various embodiments. Of course, more or less operations than those specifically described in FIG. 3A may be included in method 300, as would be understood by one of skill in the art upon reading the present descriptions.

Each of the steps of the method 300 may be performed by any suitable component of the operating environment. For example, the nodes 301, 302 shown in the flowchart of method 300 may correspond to one or more processors positioned at a different location in a distributed system. Moreover, each of the one or more processors are preferably configured to communicate with each other.

In various embodiments, the method 300 may be partially or entirely performed by a controller, a processor, etc., or some other device having one or more processors therein. The processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

As mentioned above, FIG. 3A includes different nodes 301, 302, each of which represent one or more processors, controllers, computer, etc., positioned at a different location in a multi-tiered data storage system. For instance, node 301 may include one or more processors in an electronic device at a user location (e.g., see processor 216 of FIG. 2 above). Moreover, node 302 may include one or more processors which are electrically coupled to an electronic device at an administrator's location (e.g., see controller 217 of FIG. 2 above). Accordingly, commands, data, requests, etc., may be sent between the nodes 301, 302 depending on the approach. Moreover, it should be noted that the various processes included in method 300 are in no way intended to be limiting, e.g., as would be appreciated by one skilled in the art after reading the present description. For instance, data sent from node 301 to node 302 may be prefaced by a request sent from node 302 to node 301 in some approaches.

As shown, operation 304 of method 300 includes experiencing an issue at node 301. The issue may correspond to functionality of an operating system implemented by an electronic device at node 301 (e.g., mobile phone). For example, a user may be having trouble successfully resetting their password on a mobile software application downloaded on their mobile phone.

In situations where the issue involves an electronic device (e.g., software programming implemented thereon) and cannot be successfully resolved at node 301, method 300 proceeds to operation 306. There, operation 306 includes sending a request for assistance to node 302. In other words, operation 306 includes sending a request for assistance with a software programming issue experienced at node 301. According to an example, a user having issues updating the operating software on their mobile phone at node 301 may send an assistance request to a remote IT department at node 302, e.g., as would be appreciated by one skilled in the art after reading the present description.

Looking to node 302, method 300 proceeds to operation 308 in response to receiving the request sent from node 301. There, operation 308 includes evaluating the request. Furthermore, operation 310 includes generating an initial sequence of operational instructions designed to satisfy the received request. In other words, operation 308 includes inspecting the request and assessing options as to how the request may be satisfied, while operation 310 includes deciding how to satisfy the request.

According to an example, which is in no way intended to limit the invention, operation 308 includes extracting keywords from the request and/or information provided (e.g., by an administrator) in response to receiving the request. Those keywords may thereby be used in operation 310 to develop (e.g., generate) a list of operational instructions (e.g., steps) that have been combined in an effort to solve the specific request. In preferred approaches, one or more machine learning models may be used to evaluate a received request and/or generate a proposed response to the request. For example, a machine learning module having trained models may be located at node 302 (e.g., see machine learning module 238 of FIG. 2 above).

It follows that the initial sequence of operational instructions configured to address a received request may be generated automatically in response to evaluating the request. This significantly improves the efficiency with which requests for assistance can be evaluated and addressed. For example, by identifying keywords in received information, an administrator may simply verbally describe and/or handwrite a proposed solution to a situation. The extracted keywords can be used to automatically generate a sequence (e.g., list) of operational instructions that are configured to address the situation.

With continued reference to FIG. 3A, operation 312 includes sending the initial list of operational instructions developed in operation 310, back to node 301. Looking now to node 301, method 300 proceeds to operation 314 in response to receiving the initial sequence of operational instructions. There, operation 314 includes inspecting the initial sequence of operational instructions and identifying contradicting ones of the operational instructions therein. With respect to the present description, it should be noted that “contradicting operational instructions” include operational instructions that overlap and therefore cannot both be performed successfully. Contradicting operational instructions may result from combining aspects of different proposed solutions to an issue, options included in a proposed solution, etc. It follows that contradicting operational instructions can achieve a same or similar result using different processes, or achieve different results using different processes.

Operation 316 further includes comparing differences between the contradicting operational instructions, while operation 318 includes rectifying the contradicting operational instructions by modifying the initial sequence of operational instructions. In other words, operation 318 includes deduplicating the contradicting operational instructions. This avoids performance errors from being experienced in addition to improving the efficiency of the overarching process by reducing the number of instructions that are performed, e.g., as would be appreciated by one skilled in the art after reading the present description.

Referring momentarily to FIG. 3B, exemplary sub-operations of modifying an initial sequence of operational instructions to overcome contradicting operational instructions are illustrated in accordance with one embodiment. It follows that one or more of these sub-operations may be used to perform operation 318 of FIG. 3A. However, it should be noted that the sub-processes of FIG. 3B are illustrated in accordance with one embodiment which is in no way intended to limit the invention.

As shown, sub-operation 350 includes analyzing the contradicting operational instructions. In preferred approaches the contradicting operational instructions are analyzed using a trained machine learning model. As previously mentioned, machine learning models may be trained to generate sequences of operational instructions (e.g., sequence of steps) that are configured to overcome issues when performed. Similarly, machine learning models may be trained to compare the impacts experienced as a result of implementing one operational instruction compared to another.

The machine learning models may be trained in a supervised, semi-supervised, unsupervised, etc. manner, using past operational information, training data received from a repository, or any other desired information. In some approaches, contradicting operational instructions are evaluated to determine a relative amount of computational overhead that is associated with each. Accordingly, operational instructions that introduce a least amount of computational overhead may be selected for implementation. The machine learning models are thereby able to improve operational efficiency by selectively promoting more efficient operational instructions and avoiding less efficient ones.

Accordingly, the machine learning model may be used to generate a deduplication scheme for the contradicting operational instructions. See sub-operation 352. Again, this deduplication scheme is generated based at least in part on the analysis performed in sub-operation 350. Sub-operation 354 further includes applying the deduplication scheme to the contradicting operational instructions. As noted above, this removes at least some of the contradicting operational instructions, resulting in a modified sequence of operational instructions which do not contradict each other.

Returning now to FIG. 3A, the modified sequence of operational instructions generated in operation 318 is preferably inspected for accuracy before being implemented. As noted above, the initial sequence of operational instructions as well as the modified sequence of operational instructions may be generated by one or more machine learning models. Thus, while operation 318 may remove contradicting operational instructions, the modified sequence of operational instructions may further be compared against known information to also ensure accuracy.

Accordingly, operation 320 includes comparing the modified sequence of operational instructions to known information. With respect to the present description, “known information” is intended to refer to sources of information that have been verified for accuracy. For example, the known information may include product manuals originating from a manufacturer of a mobile phone experiencing the present issue. In other examples, known information may be extracted from help tutorials, advertising literature, previous operations, etc., or any other type of known information that is associated with the initial sequence received.

Proceeding to operation 322, differences between the modified sequence and the known information are identified. Moreover, operation 324 includes determining whether to adjust the modified sequence of operational instructions to reflect the known information. In other words, operation 324 includes determining whether the known information indicates the modified sequence of operational instructions should be further updated. According to some approaches, the determination may be made in operation 324 as a result of comparing the differences between the modified sequence of operational instructions and the known information.

In situations where the difference between a modified sequence and known information is inside the predetermined range, it may be determined that the modified sequence of operational instructions will produce a result that is sufficiently different than a result that would be produced by implementing the known information. Accordingly, method 300 proceeds to operation 326 in response to determining that the known information indicates the modified sequence of operational instructions should be further updated. There, operation 326 includes extracting relevant information from the known information and using it to further update the modified sequence of operational instructions. The resulting sequence of operational instructions may thereby include more, fewer, different, etc., operational instructions than those included in the modified sequence.

Although not shown, in some approaches method 300 may return to operation 320 from operation 326 such that the latest sequence of operational instructions may be compared against the known information again. It follows that operations 320, 322, 324, 326 may be repeated in an iterative fashion to further improve the accuracy and efficiency of the operational instructions in overcoming the present issue, e.g., as would be appreciated by one skilled in the art after reading the present description.

Returning to operation 324, in situations where the difference between a modified sequence and known information is outside a predetermined range, the known information is ignored and the modified sequence remains unchanged. Accordingly, method 300 is shown as jumping to operation 328 in response to determining the known information does not indicate the modified sequence should be further updated.

There, operation 328 includes implementing the resulting sequence of operational instructions. As noted above, the operational instructions are generated in some approaches to update software programming implemented in an electronic device (e.g., a user's mobile phone). It follows that performing operation 328 includes updating the software programming in the electronic device at node 301 by causing the received sequence of operational instructions to be implemented.

In preferred approaches, at least some of the operational instructions involve displaying directions that help ensure the operational instructions are implemented. For example, operational instructions include showing tips on a display of a user's mobile phone, these tips directing the user to perform one or more specific actions. Referring now to FIG. 3C, exemplary sub-operations of implementing an operational instruction are illustrated in accordance with one embodiment. It follows that one or more of these sub-operations may be used in an iterative fashion to perform operation 328 of FIG. 3A for each of the operational instructions. However, it should be noted that the sub-processes of FIG. 3C are illustrated in accordance with one embodiment which is in no way intended to limit the invention.

As shown, sub-operation 370 includes updating information displayed on a UI of the electronic device experiencing the issue. The UI is preferably updated to include directions (e.g., hints, suggestions, tips, highlighted portions of the UI, animations, etc.) that are associated with performing the present operational instruction. These directions are preferably configured to instruct a user to interact with the UI of the electronic device in a particular fashion. The directions may thereby encourage a user to update the operating system and/or a software application running therein as desired. In other words, the directions provide an effective display of information for a user requesting assistance with a particular issue.

For example, in some approaches sub-operation 370 includes highlighting a specific area of the UI on an electronic device experiencing an issue. As noted above, the highlighted area of the UI may be directing a user's attention to a particular detail requesting their input. In another example, sub-operation 370 includes inserting prompt text in one or more locations of the UI. In other words, sub-operation 370 may include providing sample entries for one or more prompts displayed on the UI. It follows that sub-operation 370 preferably gives a user additional context about how to overcome the issue they are faced with.

Proceeding to sub-operation 372, an input is received from the user. In other words, the user eventually implements the present operational instruction in response to the updated information displayed on the UI. Sub-operation 374 further includes determining whether the input received has satisfied the present operational instruction. While information displayed on the UI is preferably updated to offer additional guidance to a user attempting to implement a present operational instruction, errors may still be made. For example, a user may misunderstand the directions and perform an undesired change to the operating system of an electronic device being updated.

In response to determining that the given operational instruction has not been successfully performed, the flowchart of FIG. 3C is shown as returning to sub-operation 370. There, the UI may be updated to display a variation of the directions previously displayed for the given operational instruction. As a result, a different input is preferably received from the user at sub-operation 372. However, in response to determining that the given operational instruction has not been successfully performed, the flowchart proceeds from sub-operation 374 to sub-operation 376. There, sub-operation 376 includes advancing to a next one of the operational instructions in the present sequence, before repeating to sub-operation 370 to ensure the next operational instruction is successfully implemented.

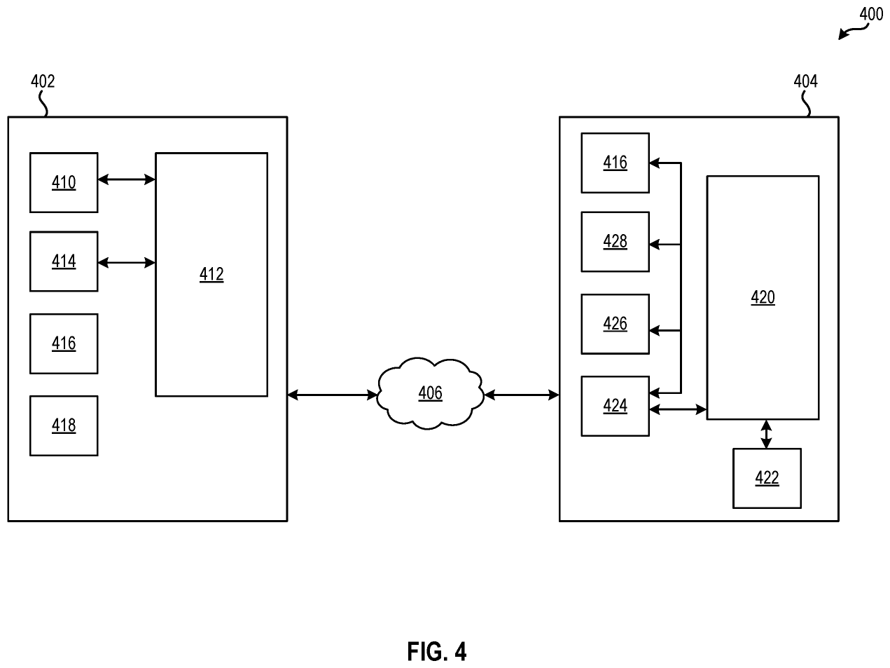

Looking now to FIG. 4, an illustrative system 400 is shown in accordance with an in-use example, which is in no way intended to be limiting. As an option, the present system 400 may be implemented in conjunction with features from any other embodiment listed herein, such as those described with reference to the other FIGS., such as FIGS. 2-3C. However, such system 400 and other implementations presented herein may be used in various applications and/or in permutations which may or may not be specifically described in the illustrative embodiments listed herein. Further, the system 400 presented herein may be used in any desired environment. Thus FIG. 4 (and the other FIGS.) may be deemed to include any possible permutation.

The distributed system 400 of FIG. 4A includes an administrator device 402 and a user device 404 are connected over a network 406. The administrator device 402 includes a voice processing unit 410 that is coupled to a training module 412. Accordingly, audible inputs received from an administrator may be translated into a digital format and evaluated by the voice processing unit 410. This information may further be used to train one or more machine learning models using the training module 412.

Software configuration module 414 is also connected to the training module 412. The software configuration module 414 is able to identify and extract different details about an operating system and/or UI. For example, the configuration module 414 is able to automatically identify the orientation, location, shape, size, color, etc. of various items currently displayed on a UI. A data extraction module 416 and data generation modules 418 are also included at the administrator device 402 and may be connected to a central controller of an electronic device, e.g., as would be appreciated by one skilled in the art after reading the present description.

Looking to user device 404, a UI 420 is connected to a guidance module 422 that is configured to update information displayed in the UI 420. An operational controller 424 is also connected to the UI 420 and may be used to adjust (e.g., change) the information displayed in the UI 420. Controller 424 is also connected to a repository 426 and comparator 428. The repository 426 preferably includes known information about the UI 420 and the user device 404 as a whole that may be compared against generated sequences, e.g., as described herein. Moreover, comparator 428 may be used to compare contradicting portions of sequences, e.g., as described herein. The user device 404 further includes a data extraction module 416.

Accordingly, by implementing approaches herein, detailed instructions may be presented to users seeking assistance. These instructions can be delivered and implemented remotely, and can be delivered across locations of a distributed network. This improves users' experience while interacting with electronic devices like mobile phones, tablets, etc.

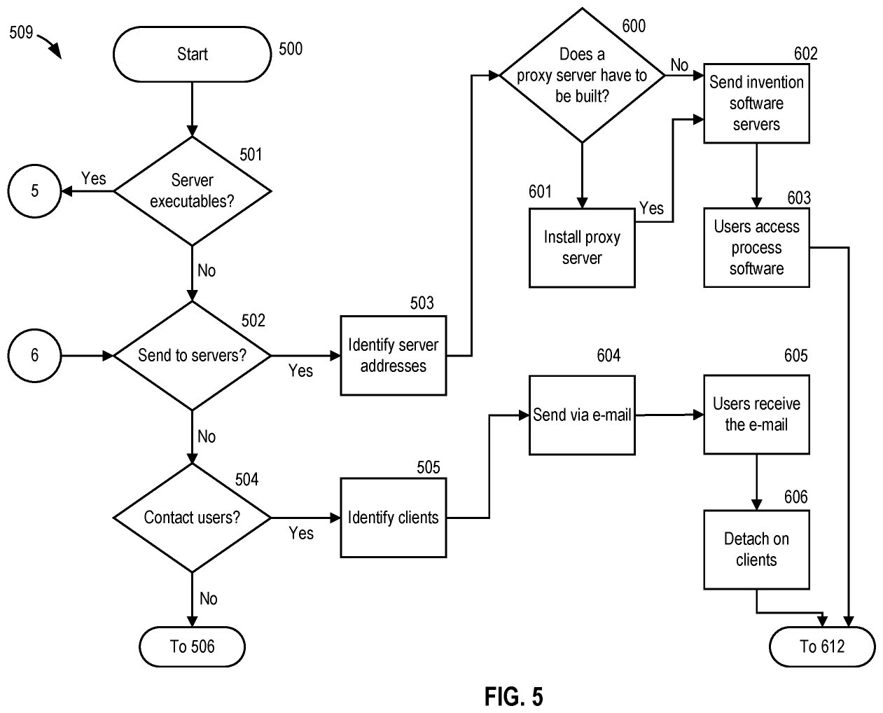

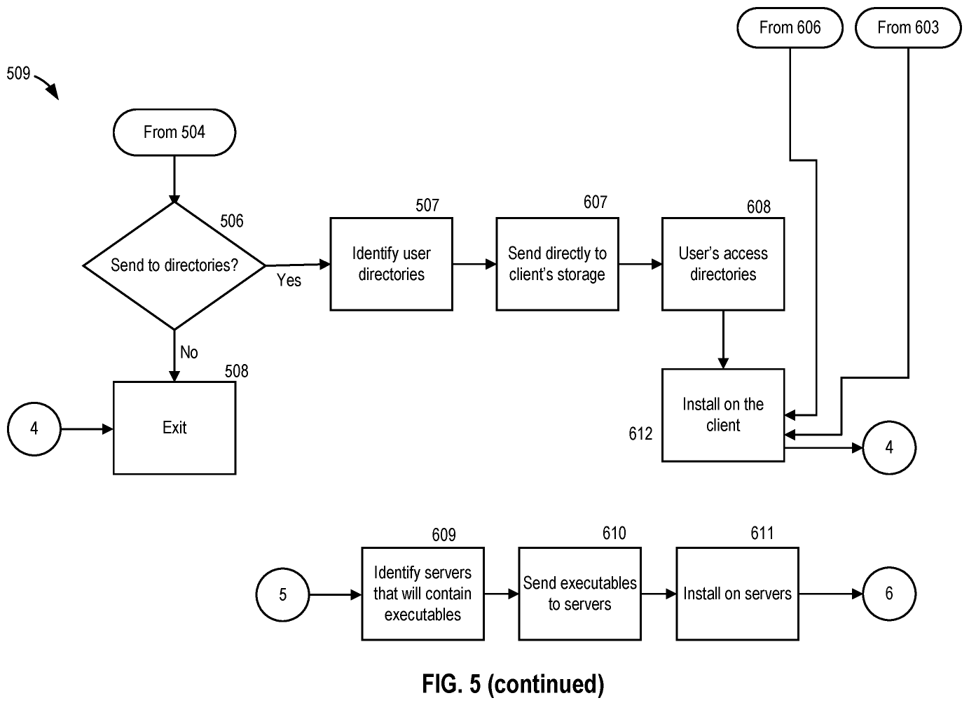

Now referring to FIG. 5, a flowchart of a method 509 is shown according to one embodiment. The method 509 may be performed in accordance with the present invention in any of the environments depicted in FIGS. 1-4, among others, in various embodiments. Of course, more or fewer operations than those specifically described in FIG. 5 may be included in method 509, as would be understood by one of skill in the art upon reading the present descriptions.

Each of the steps of the method 509 may be performed by any suitable component of the operating environment. For example, in various embodiments, the method 509 may be partially or entirely performed by a processing circuit, e.g., such as an IaC access manager, or some other device having one or more processors therein. The processor, e.g., processing circuit(s), chip(s), and/or module(s) implemented in hardware and/or software, and preferably having at least one hardware component, may be utilized in any device to perform one or more steps of the method 509. Illustrative processors include, but are not limited to, a central processing unit (CPU), an application specific integrated circuit (ASIC), a field programmable gate array (FPGA), etc., combinations thereof, or any other suitable computing device known in the art.

While it is understood that the process software associated with automatically generating sequences of procedures configured to integrate with the operating system of an electronic device to update software therein may be deployed by manually loading it directly in the client, server, and proxy computers via loading a storage medium such as a CD, DVD, etc., the process software may also be automatically or semi-automatically deployed into a computer system by sending the process software to a central server or a group of central servers. The process software is then downloaded into the client computers that will execute the process software. Alternatively, the process software is sent directly to the client system via e-mail. The process software is then either detached to a directory or loaded into a directory by executing a set of program instructions that detaches the process software into a directory. Another alternative is to send the process software directly to a directory on the client computer hard drive. When there are proxy servers, the process will select the proxy server code, determine on which computers to place the proxy servers' code, transmit the proxy server code, and then install the proxy server code on the proxy computer. The process software will be transmitted to the proxy server, and then it will be stored on the proxy server.

With continued reference to method 509, step 500 begins the deployment of the process software. An initial step is to determine if there are any programs that will reside on a server or servers when the process software is executed (501). If this is the case, then the servers that will contain the executables are identified (609). The process software for the server or servers is transferred directly to the servers' storage via FTP or some other protocol or by copying though the use of a shared file system (610). The process software is then installed on the servers (611).

Next, a determination is made on whether the process software is to be deployed by having users access the process software on a server or servers (502). If the users are to access the process software on servers, then the server addresses that will store the process software are identified (503).

A determination is made if a proxy server is to be built (600) to store the process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required, then the proxy server is installed (601). The process software is sent to the (one or more) servers either via a protocol such as FTP, or it is copied directly from the source files to the server files via file sharing (602). Another embodiment involves sending a transaction to the (one or more) servers that contained the process software, and have the server process the transaction and then receive and copy the process software to the server's file system. Once the process software is stored at the servers, the users via their client computers then access the process software on the servers and copy to their client computers file systems (603). Another embodiment is to have the servers automatically copy the process software to each client and then run the installation program for the process software at each client computer. The user executes the program that installs the process software on his client computer (612) and then exits the process (508).

In step 504 a determination is made whether the process software is to be deployed by sending the process software to users via e-mail. The set of users where the process software will be deployed are identified together with the addresses of the user client computers (505). The process software is sent via e-mail (604) to each of the users' client computers. The users then receive the e-mail (605) and then detach the process software from the e-mail to a directory on their client computers (606). The user executes the program that installs the process software on his client computer (612) and then exits the process (508).

Lastly, a determination is made on whether the process software will be sent directly to user directories on their client computers (506). If so, the user directories are identified (507). The process software is transferred directly to the user's client computer directory (607). This can be done in several ways such as, but not limited to, sharing the file system directories and then copying from the sender's file system to the recipient user's file system or, alternatively, using a transfer protocol such as File Transfer Protocol (FTP). The users access the directories on their client file systems in preparation for installing the process software (608). The user executes the program that installs the process software on his client computer (612) and then exits the process (508).

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving an initial sequence of operational instructions configured to update software programming in an electronic device;
identifying contradicting ones of the operational instructions in the initial sequence;
comparing differences between the contradicting operational instructions;
rectifying the contradicting operational instructions by modifying the initial sequence of operational instructions; and
updating the software programming in the electronic device by implementing the modified sequence of operational instructions.

2. The computer-implemented method of claim 1, wherein implementing the modified sequence includes, for each of the operational instructions in the modified sequence:
updating information displayed on a user interface (UI) of the electronic device to include directions that correspond to performing the given operational instruction;
receiving an input from a user; and
in response to determining the given operational instruction has been performed, progressing to a next operational instruction.

3. The computer-implemented method of claim 2, wherein updating information displayed on the UI of the electronic device includes highlighting a specific area of the UI and/or inserting prompt text.

4. The computer-implemented method of claim 1, comprising:
comparing the modified sequence of operational instructions to known information associated with the initial sequence received;
identifying differences between the modified sequence and the known information; and
determining whether to adjust the modified sequence to reflect the known information.

5. The computer-implemented method of claim 4, wherein determining whether to adjust the modified sequence to reflect the known information includes:
comparing the differences between the modified sequence and the known information; and
ignoring the known information in response to determining the differences between the modified sequence and the known information are outside a predetermined range.

6. The computer-implemented method of claim 1, wherein rectifying the contradicting operational instructions by modifying the initial sequence includes:
analyzing the contradicting operational instructions using a machine learning model; and
applying a deduplication scheme to the contradicting operational instructions, wherein the deduplication scheme is generated by the machine learning model.

7. The computer-implemented method of claim 1, wherein the initial sequence of operational instructions is generated using audio signals recorded from an individual in response to receiving a request sent from the electronic device.

8. A computer program product, comprising a computer readable storage medium having program instructions embodied therewith, the program instructions readable by a processor, executable by the processor, or readable and executable by the processor, to cause the processor to:
receive an initial sequence of operational instructions configured to update software programming in an electronic device;
identify contradicting ones of the operational instructions in the initial sequence;
compare differences between the contradicting operational instructions;
rectify the contradicting operational instructions by modifying the initial sequence of operational instructions; and
update the software programming in the electronic device by implementing the modified sequence of operational instructions.

9. The computer program product of claim 8, wherein implementing the modified sequence includes, for each of the operational instructions in the modified sequence:
updating information displayed on a user interface (UI) of the electronic device to include directions that correspond to performing the given operational instruction;
receiving an input from a user; and
in response to determining the given operational instruction has been performed, progressing to a next operational instruction.

10. The computer program product of claim 9, wherein updating information displayed on the UI of the electronic device includes highlighting a specific area of the UI and/or inserting prompt text.

11. The computer program product of claim 8, wherein the program instructions are readable and/or executable by the processor to cause the processor to:
compare the modified sequence of operational instructions to known information associated with the initial sequence received;
identify differences between the modified sequence and the known information; and
determine whether to adjust the modified sequence to reflect the known information.

12. The computer program product of claim 11, wherein determining whether to adjust the modified sequence to reflect the known information includes:
comparing the differences between the modified sequence and the known information; and
ignoring the known information in response to determining the differences between the modified sequence and the known information are outside a predetermined range.

13. The computer program product of claim 8, wherein rectifying the contradicting operational instructions by modifying the initial sequence includes:
analyzing the contradicting operational instructions using a machine learning model; and
applying a deduplication scheme to the contradicting operational instructions, wherein the deduplication scheme is generated by the machine learning model.

14. The computer program product of claim 8, wherein the initial sequence of operational instructions is generated using audio signals recorded from an individual in response to receiving a request sent from the electronic device.

15. A system, comprising:
a processor; and
logic integrated with the processor, executable by the processor, or integrated with and executable by the processor, the logic being configured to:
receive an initial sequence of operational instructions configured to update software programming in an electronic device;
identify contradicting ones of the operational instructions in the initial sequence;
compare differences between the contradicting operational instructions;
rectify the contradicting operational instructions by modifying the initial sequence of operational instructions; and
update the software programming in the electronic device by implementing the modified sequence of operational instructions.

16. The system of claim 15, wherein implementing the modified sequence includes, for each of the operational instructions in the modified sequence:
updating information displayed on a user interface (UI) of the electronic device to include directions that correspond to performing the given operational instruction;
receiving an input from a user; and
in response to determining the given operational instruction has been performed, progressing to a next operational instruction.

17. The system of claim 16, wherein updating information displayed on the UI of the electronic device includes highlighting a specific area of the UI and/or inserting prompt text.

18. The system of claim 15, wherein the logic is configured to:
compare the modified sequence of operational instructions to known information associated with the initial sequence received;
identify differences between the modified sequence and the known information; and
determine whether to adjust the modified sequence to reflect the known information.

19. The system of claim 18, wherein determining whether to adjust the modified sequence to reflect the known information includes:
comparing the differences between the modified sequence and the known information; and
ignoring the known information in response to determining the differences between the modified sequence and the known information are outside a predetermined range.

20. The system of claim 15, wherein rectifying the contradicting operational instructions by modifying the initial sequence includes:
analyzing the contradicting operational instructions using a machine learning model; and
applying a deduplication scheme to the contradicting operational instructions, wherein the deduplication scheme is generated by the machine learning model.
